(19) United States
(12) Patent Application Publication
(10) Pub. No.: US 2025/0179250 A1
(43) Pub. Date: Jun. 5, 2025

(54) PROCESS FOR THE PREPARATION OF A SULFONATED POLYARYLENESULFONE POLYMER (SP)

(71) Applicant: BASF SE, Ludwigshafen am Rhein (DE)

(72) Inventors: Martin WEBER, Ludwigshafen am Rhein (DE); Daniel MALKO, Ludwigshafen am Rhein (DE); Benjamin SCHMIDT-HANSBERG, Ludwigshafen am Rhein (DE); Carsten HENSCHEL, Hannover (DE); Oliver GRONWALD, Ludwigshafen am Rhein (DE); Joerg BELACK, Hannover (DE); Joachim STRAUCH, Ludwigshafen am Rhein (DE)

(21) Appl. No.: 18/841,733

(22) PCT Filed: Feb. 23, 2023
(86) PCT No.: PCT/EP2023/054578

§ 371 Date: Aug. 27, 2024

(30) Foreign Application Priority Data
Feb. 28, 2022 (EP) 22159251.2
Dec. 21, 2022 (EP) 22215613.5

(51) Int. Cl. C08G 75/23; B01D 53/22; B01D 61/42; B01D 71/68; C25B 13/08; H01M 8/1027; H01M 8/1032

(52) U.S. Cl. CPC C08G 75/23; B01D 53/228; B01D 61/422; B01D 71/68; C25B 13/08; H01M 8/1027; H01M 8/1032

(57) ABSTRACT

The present invention relates to a method for the preparation of a sulfonated polyarylenesulfone polymer (sP), the sulfonated polyarylenesulfone polymer (sP) obtained by the inventive process, a membrane (M) comprising the sulfonated polyarylenesulfone polymer (sP), a process for the preparation of the membrane, and the use of the membrane (M) for the separation of gases from gas mixtures.

The present invention relates to a method for the preparation of a sulfonated polyarylenesulfone polymer (sP), the sulfonated polyarylenesulfone polymer (sP) obtained by the inventive process, a membrane (M) comprising the sulfonated polyarylenesulfone polymer (sP), a process for the preparation of the membrane, and the use of the membrane (M) for the separation of gases from gas mixtures.

Politics, society and industry aim to reduce the CO₂-emissions by decarbonizing industry and mobility. In this context, green hydrogen plays a strategic role as it can substitute hydrocarbons for chemical and industrial processes, energy transformation and fuel cell propulsion in mobility applications. Renewable electrical power can be used to operate electrolysis cells to produce green, sustainable hydrogen.

A key component in electrolysis cells and electrodialysis cells are the so called polymer electrolyte membranes (PEM), which have to fulfil several requirements. They need to be ion conductive and at the same time they have to separate the gases hydrogen and oxygen. In addition, membranes have to be robust and stable for a long operation and life time with constant performance.

The state-of-the-art membranes are mainly based on fluorinated polymers with sulfonic acid side chains (PFSA's), which are known e. g. under the trade name Nafion®. Due to the complexity of the PFSA production, these polymers are still quite expensive. Furthermore, the toxicity and persistency of fluorinated chemicals raise several challenges for the production, use and recycling of these materials. Thus, science and industry try to develop more sustainable solutions to replace PFSA membranes.

One promising class of materials for these applications are polyarylenesulfone polymers. They belong to the group of high performance polymers having high heat resistance, chemical resistance, excellent mechanical properties and durability (E. M. Koch, H.-M. Walter, Kunststoffe 80 (1990) 1146; E. Döring, Kunststoffe 80, (1990) 1149, N. Inchaurondo-Nehm, Kunststoffe 98, (2008) 190).

Besides the use as engineering plastics, polyarylenesulfone polymers are also used as membrane material for water treatment.

Polyarylenesulfone polymers can be formed inter alia either via the hydroxide method, wherein a salt is first formed from the dihydroxy component and the hydroxide, or via the carbonate method.

General information regarding the formation of polyarylenesulfone polymers by the hydroxide method is found inter alia in R. N. Johnson et. al., J. Polym. Sci. A-1 5 (1967) 2375, while the carbonate method is described in J. E. McGrath et. al., Polymer 25 (1984) 1827.

Methods of forming polyarylenesulfone polymers from aromatic bishalogen compounds and aromatic bisphenols or salts thereof in an aprotic solvent in the presence of one or more alkali metal or ammonium carbonates or bicarbonates are known to a person skilled in the art and are described in EP-A 297 363 and EP-A 135 130, for example.

High-performance thermoplastics such as polyarylenesulfone polymers are formed by polycondensation reactions which are typically carried out at a high reaction temperature in polar aprotic solvents, for example DMF (dimethylformamide), DMAc (dimethylacetamide), sulfolane, DMSO (dimethylsulfoxide) and NMP (N-methyl-pyrrolidone).

For the use as membrane materials in water electrolysis or fuel cells, the polymer has to show ion conductivity, which can be achieved by functionalization of polyarylenesulfone polymers with sulfonic acid groups.

Sulfonated polyarylenesulfone polymers are known since decades. While the direct sulfonation of polyarylenesulfone polymers is leading to side reactions and allows only limited control on the degree of sulfonation, the use of the di-sulfonated aromatic dihalogensulfones, like sulfonated dichlorodiphenylsulfone (sDCDPS) as co-monomer allows the synthesis of well-defined sulfonated polyarylenesulfone polymers.

Although sulfonated polyarylenesulfone polymers show several interesting properties for the use as ion conducting membranes in fuel cell or for electrolysis, a major issue which still has to be solved is the production process itself. One challenge is the extremely long reaction time and the work-up and isolation of such copolymers on large scale, particularly if high amounts of di-sulfonated monomers are used. The condensation leads to polymer suspensions containing the sulfonated copolymer (sulfonated polyarylenesulfone polymer) and salts. After separation of the salts, usually precipitation in isopropanol is done to isolate the sulfonated polyarylenesulfone polymers, which causes huge volumes of solvent mixtures that have to be re-worked or disposed. Furthermore, a part of the product is not completely precipitated and may lead to clogging of filters during subsequent separation. Moreover, for production of the membranes, the sulfonated copolymers have to be dissolved again.

It is therefore an object of the present invention to provide a process for the preparation of a sulfonated polyarylenesulfone polymer (sP) which does not retain the disadvantages of the prior art or only in diminished form. The process should be easy to carry out. The sulfonated polyarylenesulfone polymer (sP) should be suitable for the manufacturing of membranes, especially membranes that are capable to separate hydrogen from hydrogen containing gas mixtures.

This object is achieved by a process for the preparation of a sulfonated polyarylenesulfone polymer (sP) comprising the step
i) converting a reaction mixture (R_{G}) comprising
   X mol of an aromatic dihalogensulfone component (component A)) comprising, based on the total molar amount of the aromatic dihalogensulfone component (component A)) in the reaction mixture (R_{G}),
   X¹ mol.-% of at least one sulfonated aromatic dihalogensulfone (component (A1)), and
   X² mol.-% of at least one non sulfonated aromatic dihalogensulfone (component (A2)),
   wherein
   X¹ is in the range of 25 to 70 and X² is in the range of 30 to 75,
   Y mol of at least one aromatic dihydroxy compound (component (B))
   Z mol of at least one carbonate compound (component (C)),
   wherein
   the ratio of X to Y is in the range of 0.95 to 1.05,
   and wherein
   Z is in the range of P to Q,
   wherein P is calculated according to the following equation:

P=Y*(1.05+X¹/100*1.05),
and wherein Q is calculated according to the following equation:

Q=Y*(1.05+X¹/100*1.4).

It has surprisingly been found, that by the use of the carbonate compound in amounts according to the present invention the condensation time for the preparation of the sulfonated polyarylenesulfone polymers (sP) can be reduced significantly. Moreover, by the inventive process sulfonated polyarylenesulfone polymers (sP) with high viscosity numbers are obtained. Furthermore, it was surprisingly found that membranes with good proton conductivity can be produced using the sulfonated polyarylenesulfone polymers (sP).

The present invention will be described in more detail hereinafter.

### Process

The sulfonated polyarylenesulfone polymer (sP) according to the invention is preferably prepared by converting a reaction mixture (R_{G}) comprising an aromatic dihalogensulfone component, at least one aromatic dihydroxy compound, and at least one carbonate compound. In a preferred embodiment the reaction mixture (R_{G}), moreover, comprises at least one aprotic polar solvent.

The aromatic dihalogensulfone component is also referred to as component (A). The terms aromatic dihalogensulfone component and component (A) in the present invention are used synonymously and therefore have the same meaning.

The at least one aromatic dihydroxy compound is also referred to as component (B). The terms at least one aromatic dihydroxy compound and component (B) in the present invention are used synonymously and therefore have the same meaning.

The at least one carbonate compound is also referred to as component (C). The terms at least one carbonate compound and component (C) in the present invention are used synonymously and therefore have the same meaning.

The at least one aprotic polar solvent is also referred to as component (D). The terms at least one aprotic polar solvent and component (D) in the present invention are used synonymously and therefore have the same meaning.

Another object of the present invention therefore is a process, wherein the reaction mixture (R_{G})), moreover, comprises at least one aprotic polar solvent (component (D)).

The reaction mixture (R_{G}) is the mixture which is provided for forming the sulfonated polyarylenesulfone polymer (sP). All components herein in relation to the reaction mixture (R_{G}) thus relate to the mixture which is present before the polycondensation. The polycondensation takes place to convert reaction mixture (R_{G}) into the target product, the sulfonated polyarylenesulfone polymer (sP), by polycondensation of components (A), and (B).

In step i) components (A) and (B) enter the polycondensation reaction. Component (C) acts as a base to deprotonate the hydroxyl groups of component (B). Component (D), if present, acts as a solvent.

The mixture obtained after the polycondensation which comprises the sulfonated polyarylenesulfone polymer (sP) target product is also referred to as product mixture (P_{G}). The product mixture (P_{G}) preferably furthermore comprises a halide compound and preferably the at least one aprotic polar solvent (component (D)). The halide compound is formed during the conversion of the reaction mixture (R_{G}). During the conversion first, component (C) reacts with component (B) to deprotonate component (B). Deprotonated component (B) then reacts with component (A) wherein the halide compound is formed. This process is known to the person skilled in the art.

The components of the reaction mixture (R_{G}) are preferably reacted concurrently. The individual components may be mixed in an upstream step and subsequently be reacted. It is also possible to feed the individual components into a reactor in which these are mixed and then reacted.

In the process according to the invention, the individual components of the reaction mixture (R_{G}) are preferably reacted concurrently preferably in step i). This reaction is preferably conducted in one stage. This means, that the deprotonation of component (B) and also the condensation reaction between components (A) and (B) take place in a single reaction stage without isolation of the intermediate products, for example the deprotonated species of component (B).

It is furthermore preferred that the reaction mixture (R_{G}) does not comprise toluene or monochlorobenzene. It is particularly preferred that the reaction mixture (R_{G}) does not comprise any substance which forms an azeotrope with water.

The ratio of component (A) and component (B) derives in principle from the stoichiometry of the polycondensation reaction which proceeds with theoretical elimination of hydrogen chloride and is established by the person skilled in the art in a known manner.

Preferably, the ratio of halogen end groups derived from component (A) to phenolic end groups derived from component (B) is adjusted by controlled establishment of an excess of component (B) in relation to component (A) as starting compound.

More preferably, the molar ratio of component (A) to component (B) is from 0.95 to 1.08, especially from 0.98 to 1.06, most preferably from 0.985 to 1.05.

In a preferred embodiment the ratio of X to Y is from 0.95 to 1.08, especially from 0.98 to 1.06, most preferably from 0.985 to 1.05.

More preferably, the molar ratio of component (A) to component (B) is from 0.99 to 1.01, especially from 0.992 to 1.008, most preferably from 0.995 to 1.005.

In a preferred embodiment the ratio of X to Y is from 0.99 to 1.01, especially from 0.992 to 1.008, most preferably from 0.995 to 1.005.

Preferably, the conversion in the polycondensation reaction is at least 0.9.

Process step i) for the preparation of the sulfonated polyarylenesulfone polymer (sP) is preferably carried out under conditions of the so called “carbonate method”. This means that the reaction mixture (R_{G}) is reacted under the conditions of the so called “carbonate method”. The polycondensation reaction is generally conducted at temperatures in the range from 80 to 250° C., preferably in the range from 100 to 220° C. The upper limit of the temperature is preferably determined by the boiling point of the at least one aprotic polar solvent (component (D)) at standard pressure (1013.25 mbar). The reaction is generally carried out at standard pressure. The reaction is preferably carried out over a time interval of 0.5 to 14 h, particularly in the range from 1 to 12 h.

The isolation of the obtained sulfonated polyarylenesulfone polymer (sP) obtained in the process in the product mixture (P_{G}) may be carried out for example by precipitation of the product mixture (P_{G}) in water or mixtures of water with other solvents. The precipitated sulfonated polyarylenesulfone polymer (P) can subsequently be extracted with water and then be dried. In one embodiment of the invention, the precipitate can also be taken up in an acidic medium. Suitable acids are for example organic or inorganic acids for example carboxylic acid such as acetic acid, propionic acid, succinic acid or citric acid and mineral acids such as hydrochloric acid, sulfuric acid or phosphoric acid.

The halide compound can be removed from the product mixture (P_{G}) after step i). The halide compound can be removed by measures commonly known in the art like filtration, centrifugation, decantation etc.

The present invention therefore also provides a process wherein the process furthermore comprises step
ii) filtration, centrifugation or decantation of the product mixture (P_{G}) obtained in step i).

After the polycondensation in one embodiment a conversion with an aliphatic organic halogen compound is conducted. Thereby the reactive hydroxyl groups are end-caped and the polymer is further stabilized. The conversion with an aliphatic organic halogen compound can be conducted before or after the filtration.

Preferred aliphatic organic halogen compounds are alkyl halides, in particular alkyl chlorides, having linear or branched alkyl groups having from 1 to 10 carbon atoms, in particular primary alkyl chlorides, particularly preferably methyl halide, in particular methyl chloride.

The reaction with the aliphatic organic halogen compound is preferably carried out at a temperature of from 90° to 160° C., in particular from 100° C. to 150° C. The time can vary widely and is usually at least 5 minutes, in particular at least 15 minutes. The reaction time is preferably from 15 minutes to 8 hours, in particular from 30 minutes to 4 hours.

Various methods can be used for the addition of the aliphatic organic halogen compound. The amounts added of the aliphatic organic halogen compound can moreover be stoichiometric or represent an excess, where the excess can by way of example be up to a 5-fold excess. In one preferred embodiment, the aliphatic organic halogen compound is added continuously, in particular via continuous introduction in the form of a stream of gas.

### Component (A)

Component (A), which is also referred to as the aromatic dihalogensulfone component, comprises at least at least one sulfonated aromatic dihalogensulfone and at least one non sulfonated aromatic dihalogensulfone.

The at least one sulfonated aromatic dihalogensulfone is also referred to as component (A1). The terms at least one sulfonated aromatic dihalogensulfone and component (A1) in the present invention are used synonymously and therefore have the same meaning.

The at least one non sulfonated aromatic dihalogensulfone is also referred to as component (A2). The terms at least one non sulfonated aromatic dihalogensulfone and component (A2) in the present invention are used synonymously and therefore have the same meaning.

What is meant herein by “at least one sulfonated aromatic dihalogensulfone” is precisely one sulfonated aromatic dihalogensulfone and also mixtures of two or more sulfonated aromatic dihalogensulfones. Preferably precisely one sulfonated aromatic dihalogensulfone is used.

What is meant herein by “at least one non sulfonated aromatic dihalogensulfone” is precisely one non sulfonated aromatic dihalogensulfone and also mixtures of two or more non sulfonated aromatic dihalogensulfones. Preferably precisely one non sulfonated aromatic dihalogensulfone is used.

“X” preferably means the amount of mol of component (A) in the reaction mixture (R_{G}). “X” herein preferably means the total molar amount of the aromatic dihalogensulfone component (component (A)) in the reaction mixture (R_{G}). In other words “X” means preferably the sum of the molar amount of component (A1) and component (A2) contained in component (A), preferably contained in the reaction mixture (R_{G}). “X¹” herein means the molar amount in mol.-% of component (A1) and “X²” herein means the molar amount in mol.-% of component (A2), based on the total molar amount of component (A) in the reaction mixture (R_{G}).

X¹ is generally in the range of 25 to 70 mol.-%, preferably in the range of 27.5 to 65 mol.-%, more preferably in the range of 30 to 60 mol.-%, and most preferably in the range of 32.5 to 57.5 mol.-%, in each case based on the total molar amount of the aromatic dihalogensulfone component (component (A)) in the reaction mixture (R_{G}).

X² is generally in the range of 30 to 75 mol.-%, preferably in the range of 35 to 72.5 mol.-%, more preferably in the range of 40 to 70 mol.-%, and most preferably in the range of 42.5 to 67.5 mol.-%, in each case based on the total molar amount of the aromatic dihalogensulfone component (component (A)) in the reaction mixture (R_{G}).

The amount of X¹ and X² generally adds up to 100 mol.-%.

### Component (A1)

Component (A1), which is also referred to as the sulfonated aromatic dihalogensulfone comprises preferably at least one —SO₃X³ group.

Component (A1) preferably comprises at least one —SO₃X³ group. What is meant herein by “at least one —SO₃X³ group” is that component (A1) can comprise precisely one —SO₃X³ group and also two or more —SO₃X³ groups. Component (A1) more preferably comprises two —SO₃X³ groups.

The general formula —SO₃X³ comprises the sulfonic acid functional group and also derivatives of sulfonic acid functional groups such as sulfonates. In the —SO₃X³ group(s) X³ may be hydrogen and/or one cation equivalent.

By “one cation equivalent” in the context of the present invention is meant one cation of a single positive charge or one charge equivalent of a cation with two or more positive charges, for example Li, Na, K, Mg, Ca, NH₄, preferably Na, K. Particularly preferred is Na or K.

Component (A1) is preferably selected from the group consisting of 4,4′-dichlorodiphenylsulfone-3,3′-disulfonic acid and 4,4′-difluorodiphenylsulfone-3,3′-disulfonic acid, and derivatives thereof.

The terms “sulfonic acid” and “—SO₃X³ group” in the context of the present invention are used synonymously and have the same meaning. The term “sulfonic acid” in the 4,4′-dichlorodiphenylsulfone-3,3′-disulfonic acid and 4,4′-difluorodiphenylsulfone-3,3′-disulfonic acid therefore means “—SO₃X³ group”, wherein X³ is hydrogen or a cation equivalent.

In one embodiment, component (A1) preferably comprises —SO₃X³ groups with a cation equivalent. Especially preferably, component (A1) is selected from the group consisting of 4,4′-dichlorodiphenylsulfone-3,3′-disulfonic acid, 4,4′-dichlorodiphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt.

Another object of the present invention therefore is process, wherein component (A1) comprises at least one compound selected from the group consisting of 4,4′-dichlorodiphenylsulfone-3,3′-disulfonic acid, 4,4′-dichloro-diphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodi-phenylsulfone-3,3′-disulfonic acid disodium salt and 4,4′-difluorodiphenylsulfone-3,3′-disulfonic acid dipotassium salt.

In one embodiment, component (A1) comprises not less than 70 wt %, preferably not less than 90 wt %, and more preferably not less than 98 wt % of at least one aromatic dihalogensulfone component comprising at least one —SO₃X³ group selected from the group consisting of 4,4′-dichlorodiphenylsulfone-3,3′-disulfonic acid, 4,4′-dichlorodiphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt, based on the overall weight of component (A1) in the reaction mixture (R_{G}).

In a further particularly preferred embodiment, component (A1) consists essentially of at least one aromatic dihalogensulfone comprising at least one —SO₃X³ group selected from the group consisting of 4,4′-dichlorodiphenylsulfone-3,3′-disulfonic acid, 4,4′-dichlorodiphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt. What is meant herein by “consisting essentially of” is that component (A2) comprises more than 97 wt %, preferably more than 98 wt % and more preferably more than 99 wt % of at least one aromatic dihalogensulfone comprising at least one —SO₃X³ group selected from the group consisting of 4,4′-dichlorodiphenylsulfone-3,3′-disulfonic acid, 4,4′-dichlorodiphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt, all based on the overall weight of component (A2) in reaction mixture (R_{G}).

In these embodiments, 4,4′-dichlorodiphenylsulfone-3,3′-disulfonic acid dipotassium salt and 4,4′-dichlorodiphenylsulfone-3,3′-disulfonic acid disodium salt are particularly preferable for use as component (A1).

In a further, particularly preferred embodiment, component (A1), consists of 4,4′-dichlorodiphenylsulfone-3,3′-disulfonic acid dipotassium salt or 4,4′-dichloro-diphenylsulfone-3,3′-disulfonic acid disodium salt.

### Component (A2)

Component (A2), which is also referred to as the non sulfonated aromatic dihalogensulfone component comprises preferably no —SO₃X³ groups.

Preferably, component (A2) comprises not less than 80 wt %, preferably not less than 35 90 wt %, and more preferably not less than 98 wt % of at least one aromatic dihalogensulfone selected from the group consisting of 4,4′-dichlorodiphenylsulfone and 4,4′-difluorodiphenylsulfone, based on the overall weight of component (A2) in reaction mixture (R_{G}). The weight percentages here in relation to component (A2) further relate to the sum total of the 4,4′-dichlorodiphenylsulfone used and of the 4,4′-difluorodiphenylsulfone used.

Another object of the present invention therefore is a process, wherein component (A2) comprises not less than 80 wt % of at least one aromatic dihalogensulfone selected from the group consisting of 4,4′-dichlorodiphenylsulfone and 4,4′-difluoro-diphenylsulfone, based on the overall weight of component (A2) in reaction mixture (R_{G}).

In a further particularly preferred embodiment, component (A2) consists essentially of at least one aromatic dihalogensulfone selected from the group consisting of 4,4′-dichlorodiphenyl sulfone and 4,4′-difluorodiphenyl sulfone. What is meant herein by “consisting essentially of” is that component (A2) comprises more than 99 wt %, preferably more than 99.5 wt % and more preferably more than 99.9 wt % of at least one aromatic dihalogensulfone selected from the group consisting of 4,4′-dichlorodiphenyl sulfone and 4,4′-difluorodiphenyl sulfone, all based on the overall weight of component (A2) in reaction mixture (R_{G}). In these embodiments, 4,4′-dichlorodiphenyl sulfone is particularly preferable for use as component (A2).

In a further particularly preferred embodiment, component (A2) consists essentially of 4,4′-dichlorodiphenylsulfone. What is meant herein by “consisting essentially of” is that component (A2) comprises more than 99 wt %, preferably more than 99.5 wt % and more preferably more than 99.9 wt % of 4,4′-dichlorodiphenylsulfone. In a further, particularly preferred embodiment, component (A2), consists of 4,4′-dichlorodiphenyl-sulfone.

Preferably, component (A2) is selected from the group consisting of 4,4′-dichlorodiphenylsulfone and 4,4′-difluorodiphenylsulfone.

### Component (B)

Component (B), which is also referred to as the aromatic dihydroxy compound generally comprises two hydroxy groups.

What is meant herein by “at least one aromatic dihydroxy compound” is precisely one aromatic dihydroxy compound and also mixtures of two or more aromatic dihydroxy compound. Preferably precisely one aromatic dihydroxy compound is used.

“Y” preferably means the amount of mol of component (B) in the reaction mixture (R_{G}). “Y” herein preferably means the total molar amount of the aromatic dihydroxy compound (component (B)) in the reaction mixture (R_{G}).

Preferably, component (B) is selected from the group consisting of 4,4′-dihydroxybiphenyl, 4,4′-dihydroxydiphenylsulfone, bisphenol A (2,2-bis(4-hydroxyphenyl)propane), 4,4′-dihydroxybenzophenone and hydroquinone. From among the aforementioned aromatic dihydroxy components, 4,4′-dihydroxybiphenyl, 4,4′-dihydroxydiphenyl sulfone and bisphenol A are preferable, while 4,4′-dihydroxybiphenyl is particularly preferable.

The present invention accordingly also provides a method wherein component (B) is selected from the group consisting of 4,4′-dihydroxybiphenyl, 4,4′-dihydroxydiphenyl sulfone, bisphenol A, 4,4′-dihydroxybenzophenone and hydroquinone.

Preferably, component (B) comprises not less than 80 wt %, preferably not less than 90 wt % and more preferably not less than 98 wt % of 4,4′-dihydroxybiphenyl, based on the overall weight of component (B) in reaction mixture (R_{G}).

Another object of the present invention therefore is a process, wherein component (B) comprises not less than 80 wt % 4,4′-dihydroxybiphenyl, based on the overall weight of component (B) in reaction mixture (R_{G}).

The weight percentages here in relation to component (B) further relate to the sum total of the 4,4′-dihydroxybiphenyl, 4,4′-dihydroxydiphenyl sulfone, bisphenol A (2,2-bis-(4-hydroxyphenyl)propane), 4,4′-dihydroxybenzophenone and hydroquinone used.

In a further particularly preferred embodiment, component (B) consists essentially of at least one aromatic dihydroxy component selected from the group consisting of 4,4′-dihydroxybiphenyl, 4,4′-dihydroxydiphenylsulfone, bisphenol A (2,2-bis(4-hydroxy-phenyl)propane), 4,4′-dihydroxybenzophenone and hydroquinone. What is meant 25 herein by “consisting essentially of” is that component (B) comprises more than 98 wt %, preferably more than 99.0 wt % and more preferably more than 99.5 wt % of at least one at least one aromatic dihydroxy component selected from the group consisting of 4,4′-dihydroxybiphenyl, 4,4′-dihydroxydiphenylsulfone, bisphenol A (2,2-bis(4-hydroxyphenyl)propane), 4,4′-dihydroxybenzophenone and hydroquinone, all based on the overall weight of component (B) in reaction mixture (R_{G}). In these embodiments, 4,4′-dihydroxybiphenyl, bisphenol A and 4,4′-dihydroxydiphenylsulfone are particularly preferable for use as component (B), while 4,4′-dihydroxybiphenyl is most preferable.

### Component (C)

The reaction mixture (R_{G}) comprises at least one carbonate compound as component (C). The term “at least one carbonate compound” in the present case, is understood to mean exactly one carbonate compound and also mixtures of two or more carbonate compounds. The at least one carbonate compound is preferably at least one metal carbonate. The metal carbonate is preferably anhydrous. In the present case the terms “at least one carbonate compound” and “component (C)” are used synonymously and therefore have the same meaning.

Preference is given to alkali metal carbonates and/or alkaline earth metal carbonates as metal carbonates. At least one metal carbonate selected from the group consisting of sodium carbonate, potassium carbonate and calcium carbonate is particularly preferred as metal carbonate. Potassium carbonate is most preferred.

For example, component (C) comprises not less than 50 wt %, more preferred not less than 70 wt % by weight and most preferred not less than 90 wt % of potassium carbonate based on the total weight of the at least one carbonate component in the reaction mixture (R_{G}).

Another object of the present invention therefore is a process, wherein component (C) comprises not less than 50 wt % of potassium carbonate based on the total weight of component (C) in the reaction mixture (R_{G}).

In a preferred embodiment component (C) consists of potassium carbonate. Potassium carbonate having a volume weighted average particle size of less than 200 μm is preferred as potassium carbonate more preferred less than 100 μm more even more preferred less than 70 μm and most preferred less than 50 μm. The volume weighted average particle size of the potassium carbonate is determined in a suspension of potassium carbonate in a mixture chlorobenzene/sulfolane (60/40 by weight) using a particle size analyser.

“Z” preferably means the amount of mol of component (C) in the reaction mixture (R_{G}). “Z” herein means preferably the total molar amount of the at least one carbonat component (componente (C)) in the reaction mixture (R_{G}).

Z is in the range of P to Q.

“P” is calculated according to the following equation:

$$P = Y * ( 1.05 + {X}^{1} / 100 * 1.05 )$$

In this equation Y is the value of the molar amount of component (B) in the reaction mixture (R_{G}) and X¹ is the value of the mol.-% of component (A1) in reaction mixture (R_{G}).

“Q” is calculated according to the following equation:

$$Q = Y * ( 1.05 + {X}^{1} / 100 * 1.4 )$$

In this equation Y is also the value of the molar amount of component (B) in the reaction mixture (R_{G}) and X¹ is also the value of the mol.-% of component (A1) in reaction mixture (R_{G}).

For the composition used in inventive example 3 P is 2.82 while Q is 3.06. The range of Z therefore is from 2.82 to 3.06 and 2.9 mol are used.

### Component (D)

The reaction mixture (R_{G}) comprises preferably at least one aprotic polar solvent as component (D). “At least one aprotic polar solvent”, according to the invention, is understood to mean exactly one aprotic polar solvent and also mixtures of two or more aprotic polar solvents. In the present case the terms “at least one aprotic polar solvent” and “component (D)” are used synonymously and therefore have the same meaning.

Suitable aprotic polar solvents are, for example, selected from the group consisting of anisole, dimethylformamide, dimethylsulfoxide, sulfolane, N-methylpyrrolidone, N-ethylpyrrolidone and N-dimethylacetamide.

Preferably, component (D) is selected from the group consisting of N-methylpyrrolidone, N-dimethylacetamide, dimethylsulfoxide and dimethylformamide. N-methylpyrrolidone is particularly preferred as component (D).

It is preferred that component (D) comprises not less than 50 wt %, preferably not less than 70 wt % and more preferably not less than 90 wt % of at least one solvent selected from the group consisting of N-methylpyrrolidone, N-dimethylacetamide, dimethylsulfoxide and dimethylformamide based on the total weight of component (D) in the reaction mixture (R_{G}). N-methylpyrrolidone is particularly preferred as component (D).

Another object of the present invention therefore is a process, wherein component (D) comprises not less than 50 wt % of at least one solvent selected from the group consisting of N-methylpyrrolidone, N-dimethylacetamide, dimethylsulfoxide and dimethyl-formamide based on the total weight of component (D) in the reaction mixture (R_{G}).

In a preferred embodiment, component (D) consists of N-methylpyrrolidone. N-methylpyrrolidone is also referred to as NMP or N-methyl-2-pyrrolidone.

### Sulfonated Polyarylenesulfone Polymer (sP)

Sulfonated polyarylenesulfone polymers (sP) are a class of polymers known to the person skilled in the art. In principle, it is possible to use any of the sulfonated polyarylenesulfone polymers (sP) that are known to the person skilled in the art and/or that can be produced by known methods. Appropriate methods for the preparation of sulfonated polyarylenesulfone polymers (sP) are explained at a later stage below.

Preferred sulfonated polyarylenesulfone polymers (sP) comprise repeating units of the general formula I:
where

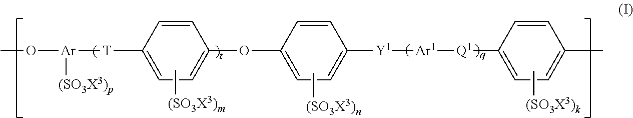

t and q: are each independently 0, 1, 2 or 3,
Q¹, T and Y¹: are each independently a chemical bond or selected from —O—, —S—, —SO₂—, —S(═O)—, —C(═O)—, —N═N—, and —CR^{a}R^{b}—,
   wherein R^{a} and R^{b} are each independently a hydrogen atom or a C₁-C₁₂-alkyl, C₁-C₁₂-alkoxy or C₆-C₁₈-aryl group, and wherein at least one of Q, T and Y is —SO₂—,
Ar and Ar¹: are each independently C₆-C₁₈ aryl, wherein said C₆-C₁₈ aryl is unsubstituted or substituted with at least one substituent selected from C₁-C₁₂ alkyl, C₁-C₁₂ alkoxy, C₆-C₁₈ aryl, halogen and —SO₃X,
p, m, n, and k: are each independently 0, 1, 2, 3 or 4, with the proviso that the sum total of p, m, n and k is not less than 1, and
X³: is hydrogen or one cation equivalent.

Another object of the present invention therefore is a sulfonated polyarylenesulfone polymer (sP), wherein the sulfonated polyarylenesulfone polymer (sP) comprises repeating units of the general formula (I):

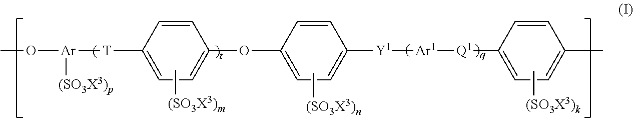

where
t and q: are each independently 0, 1, 2 or 3,
Q¹, T and Y¹: are each independently a chemical bond or selected from —O—, —S—, —SO₂—, —S(═O)—, —C(═O)—, —N═N—, and —CR^{a}R^{b}—,
   wherein R^{a} and R^{b} are each independently a hydrogen atom or a C₁-C₁₂-alkyl, C₁-C₁₂-alkoxy or C₆-C₁₈-aryl group, and wherein at least one of Q, T and Y is —SO₂—,
Ar and Ar¹: are each independently C₆-C₁₈ aryl, wherein said C₆-C₁₈ aryl is unsubstituted or substituted with at least one substituent selected from C₁-C₁₂ alkyl, C₁-C₁₂ alkoxy, C₆-C₁₈ aryl, halogen and —SO₃X,
p, m, n, and k: are each independently 0, 1, 2, 3 or 4, with the proviso that the sum total of p, m, n and k is not less than 1, and
X³: is hydrogen or one cation equivalent.

In a preferred embodiment the sulfonated polyarylenesulfone polymers (sP) comprises at least 80 wt % of repeating units of the general formula (I) based on the total weight of the sulfonated polyarylenesulfone polymers (sP).

If Q¹, T, or Y¹, with the abovementioned preconditions, is a chemical bond, this means that the adjacent group on the left-hand side and the adjacent group on the right-hand side have direct linkage to one another by way of a chemical bond.

R^{a} and R^{b} are each independently hydrogen or C₁-C₁₂ alkyl.

Preferred C₁-C₁₂ alkyl groups include linear and branched, saturated alkyl groups of 1 to 12 carbon atoms. The following moieties are suitable in particular: C₁-C₆ alkyl, such as methyl, ethyl, n-propyl, i-propyl, n-butyl, sec-butyl, 2- or 3-methylpentyl or comparatively long-chain moieties such as unbranched heptyl, octyl, nonyl, decyl, undecyl, lauryl, and the branched analogs thereof.

Alkyl moieties in the C₁-C₁₂ alkoxy groups used include the above-defined alkyl groups of 1 to 12 carbon atoms. Preferably used cycloalkyl moieties include in particular C₃-C₁₂ cycloalkyl moieties, e.g., cyclopropyl, cyclobutyl, cyclopentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, -cyclohexylmethyl, -dimethyl, -trimethyl.

Ar and Ar¹ are each independently C₆-C₁₈ aryl. Proceeding from the starting materials hereinbelow, Ar preferably derives from an electron-rich aromatic substance very susceptible to electrophilic attack, preferably selected from the group consisting of sulfonated or unsulfonated hydroquinone, resorcinol, dihydroxynaphthalene, in particular 2,7-dihydroxynaphthalene and 4,4′-bisphenol. Ar¹ is preferably an unsubstituted C₆ or C₁₂ arylene group.

Ar and Ar¹ in the preferred embodiment of formula (I) are each preferably selected independently from sulfonated or unsulfonated 1,4-phenylene, 1,3-phenylene, naphthylene, in particular 2,7-dihydroxynaphthalene and 4,4′-bisphenylene.

Preferred are sulfonated polyarylenesulfone polymer (sP) having one or more of the following structural units (Ia) to (Io):

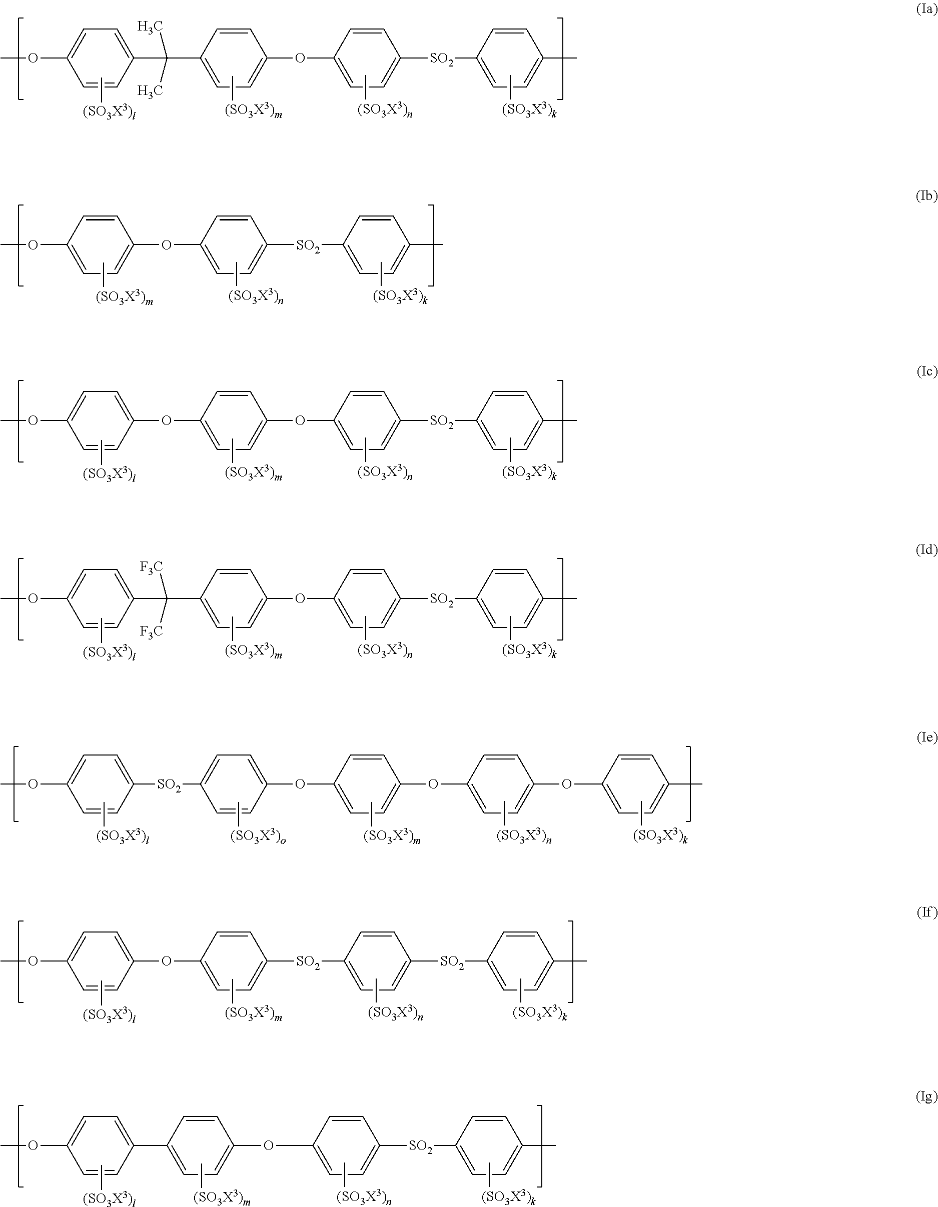

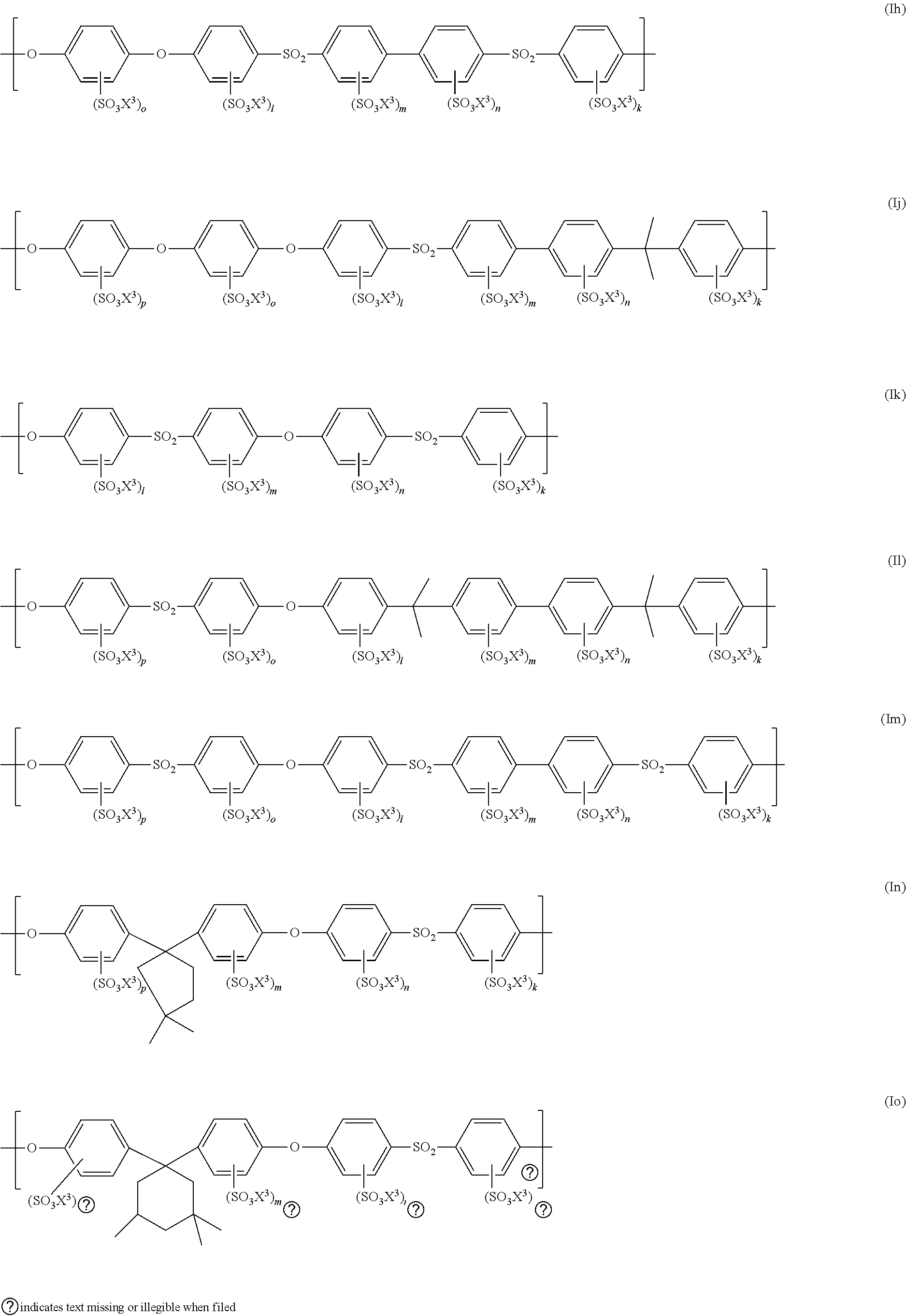

where
l, k, m, n, o, p are each independently 0, 1, 2, 3 or 4 subject to the proviso that the sum total of l, k, m, n, o and p is 1, and
X³ is hydrogen or one cation equivalent.

By “one cation equivalent” in the context of the present invention is meant one cation of a single positive charge or one charge equivalent of a cation with two or more positive charges, for example Li, Na, K, Mg, Ca, NH₄, preferably Na, K.

In addition to the preferred building blocks (Ia) to (Io), preference is also given to those structural units in which one or more sulfonated or unsulfonated 1,4-dihydroxyphenyl units are replaced by resorcinol or dihydroxynaphthalene.

Copolymers constructed of the various structural units in combination or of sulfonated and non-sulfonated structural units are also usable.

Structural units (Ia), (Ib), (Ig) and (Ik) or copolymers thereof are used with particular preference as repeat unit of general formula (I).

In one particularly preferred embodiment, Ar is 1,4-phenylene, t is 1, T is a chemical bond, Y¹ is —SO₂—, q is 0, p is 0, m is 0, n is 1 and k is 1. Sulfonated polyphenylenesulfones constructed of this recited structural repeat unit are denoted sPPSU.

In a particularly preferred embodiment, Ar is 1,4-phenylene, t is 0, Y is —SO₂—, q is 0, n is 0 and k is 0. Polyarylenesulfones constructed of this recited structural repeat unit are denoted sulfonated polyether ether sulfones (sPEES).

In one advantageous embodiment, the sulfonated polyarylenesulfone polymer (sP) comprises
a nonsulfonated repeat unit of formula (1)

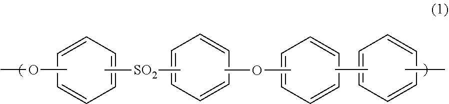

and a sulfonated repeat unit of formula (2)

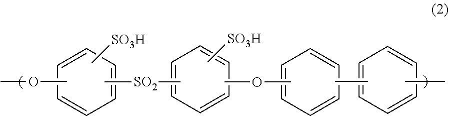

In particular, the sulfonated polyarylenesulfone polymer (sP) consists exclusively of non-sulfonated repeating units of formula (1) and sulfonated repeat units of formula (2).

In a very advantageous embodiment, the sulfonated polyarylenesulfone polymer (sP) comprises
a nonsulfonated repeat unit of formula (Ia)

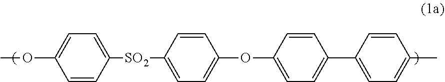

and a sulfonated repeat unit of formula (1 b)

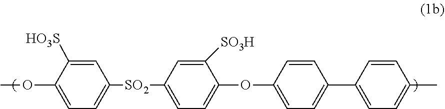

In particular, the sulfonated polyarylenesulfone polymer (sP) consists exclusively of non-sulfonated repeat units of formula (Ia) and sulfonated repeating units of formula (Ib).

The sulfonated polyarylenesulfone polymers (sP) used according to the present invention preferably have a viscosity number of 20 ml/g to 250 ml/g, preferably of 50 ml/g to 200 ml/g. This viscosity number is quantified according to DIN EN ISO 1628-1 in a 1% solution of N-methylpyrrolidone (NMP) at 25° C. The measurement can also be done at lower polymer concentration, e.g. 0.5%.

The weight average molecular weight (M_{w}) of the sulfonated polyarylenesulfone polymer (sP) used in the method of the present invention is generally in the range from 10 000 to 250 000 g/mol, preferably in the range from 15 000 to 200 000 g/mol and more preferably in the range from 18 000 to 150 000 g/mol. The weight average molecular weights (M_{w}) are measured using gel permeation chromatography (GPC). Dimethylacetamide (DMAc) was used as solvent and narrowly distributed polymethyl methacrylate was used as standard in the measurement.

The sulfonated polyarylenesulfone polymers (sP) according to the present invention preferably have a viscosity number of equal or greater than 80 ml/g, preferably of equal or greater than 85 ml/g and particularly preferred of equal or greater than 90 ml/g. This viscosity number is quantified according to DIN EN ISO 1628-1 in a 0.5% solution of N-methylpyrrolidone (NMP) at 25° C.

The sulfonated polyarylenesulfone polymers (sP) according to the present invention preferably have a viscosity number of 80 to 150 ml/g, preferably of 85 ml/g to 140 ml/g. This viscosity number is quantified according to DIN EN ISO 1628-1 in a 0.5% solution of N-methylpyrrolidone (NMP) at 25° C.

The weight average molecular weight (M_{w}) of the sulfonated polyarylenesulfone polymer (sP) used in the method of the present invention is generally in the range from 40 000 to 250 000 g/mol, preferably in the range from 50 000 to 200 000 g/mol and more preferably in the range from 60 000 to 150 000 g/mol. The weight average molecular weights (M_{w}) are measured using gel permeation chromatography (GPC). Dimethylacetamide (DMAc) was used as solvent and narrowly distributed polymethyl methacrylate was used as standard in the measurement.

nother object of the present invention therefore is the sulfonated polyarylenesulfone polymer (sP) obtained by the inventive process.

Another object of the present invention therefore is the sulfonated polyarylenesulfone polymer (sP) comprising repeating units of the general formula (I).

In another embodiment X³ is X^{3a} or X^{3b}.

Another object of the present invention is a sulfonated polyarylenesulfone polymer (sP) containing repeating units comprising at least one —SO₃X^{3a} group and/or at least one —SO₃X^{3b} group, wherein X^{3a} and X^{3b} are each independently from each other at least one selected from the group consisting of hydrogen and cation equivalents, wherein at least 50 mol % of the total amount of X^{3a} and X^{3b} contained in the sulfonated polyarylenesulfone polymer (sP) are potassium cations.

It has surprisingly been found, that from the inventive sulfonated polyarylenesulfone polymers (sP) membranes with good proton conductivity can be produced. The membranes (M), moreover surprisingly show less water swelling and a less change of size compared to membranes produced from sulfonated polyarylenesulfone polymers known in the state of the art.

The sulfonated polyarylenesulfone polymers (sP) according to the invention contain repeating units comprising at least one —SO₃X^{3a} group and/or at least one —SO₃X^{3b} group. The repeating units containing repeating units comprising at least one —SO₃X^{3a} group and/or at least one —SO₃X^{3b} group in the present case are also denominated as sulfonated repeating units.

The sulfonated polyarylenesulfone polymer (sP) according to the invention can contain sulfonated repeating units and non sulfonated repeating units. Non sulfonated repeating units are understood to mean repeating units that do not contain —SO₃X^{3a} and —SO₃X^{3b} groups.

In a preferred embodiment the sulfonated polyarylenesulfone polymer (sP) contains in the range of 25 to 70 mol.-%, preferably in the range of 27.5 to 65 mol.-%, more preferably in the range of 30 to 60 mol.-%, and most preferably in the range of 32.5 to 57.5 mol.-% of sulfonated repeating units, in each case based on the total molar amount of the sulfonated polyarylenesulfone polymer (sP).

In a preferred embodiment the sulfonated polyarylenesulfone polymer (sP) contains in the range of 30 to 75 mol.-%, preferably in the range of 35 to 72.5 mol.-%, more preferably in the range of 40 to 70 mol.-%, and most preferably in the range of 42.5 to 67.5 mol.-% of non sulfonated repeating units, in each case based on the total molar amount of the sulfonated polyarylenesulfone polymer (sP).

The amount of sulfonated repeating units and non sulfonated repeating units in the sulfonated polyarylenesulfone polymer (sP) generally adds up to 100 mol.-%.

The at terms “at least one —SO₃X^{3a} group” and “at least one —SO₃X^{3b} group” in the present case are subsumed under the term “at least one —SO₃X³ group”. The term “at least one —SO₃X³ group” can mean “at least one —SO₃X^{3a} group” and/or “at least one —SO₃X³b group”.

“X^{3a}” and “X^{3b}” are herein subsumed under “X³”. The term “at least one —SO₃X³ group” can mean “at least one —SO₃X^{3a} group” and/or “at least one —SO₃X^{3b} group”.

All explanations in view of the “at least one —SO₃X³ group” also hold true for the “at least one —SO₃X^{3a} group” and the “at least one —SO₃X^{3b} group”.

Moreover, all explanations in view of “X³” also hold true for “X^{3a}” and “X^{3b}”.

The term “at least one —SO₃X³ group” in the present case, is understood to mean exactly one —SO₃X³ group and also two, three or four —SO₃X³ groups. In a preferred embodiment the sulfonated repeating units contain 1 to 4 —SO₃X³ groups, more preferred 1 to 3 —SO₃X³ groups and especially preferred 1 to 2 —SO₃X³ groups. In a particularly preferred embodiment the sulfonated repeating units contain 2 —SO₃X³ groups.

X^{3a} and X^{3b} are each independently from each other at least one selected from the group consisting of hydrogen and cation equivalents. The term “cation equivalent” in the context of the present invention is meant one cation of a single positive charge or one charge equivalent of a cation with two or more positive charges, for example Li, Na, K, Mg, Ca, NH₄, preferably Na, K in each case under the proviso that at least 50 mol %, more preferred at least 55 mol %, even more preferred from 60 to 80 mol % and particularly preferred from 62.5 to 77.5 mol % of the total amount of X^{3a} and X^{3b} contained in the sulfonated polyarylenesulfone polymer (sP) are potassium cations.

In a very advantageous embodiment, the sulfonated polyarylenesulfone polymer (sP) comprises
a nonsulfonated repeat unit of formula (Ia)

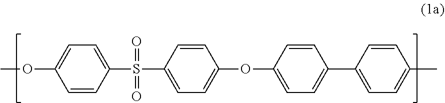

and a sulfonated repeat unit of formula (1 b)

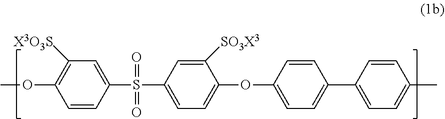

In particular, the sulfonated polyarylenesulfone polymer (sP) consists exclusively of non-sulfonated repeat units of formula (Ia) and sulfonated repeating units of formula (Ib).

The sulfonated polyarylenesulfone polymer (sP) is suitable for the preparation of membranes (M). The sulfonated polyarylenesulfone polymer (sP) obtained by the inventive process can be used in a membrane (M).

Another object of the present invention is therefore also the use of the sulfonated polyarylenesulfone polymer (sP) obtainable by the inventive process in a membrane (M).

The membrane (M) can be prepared from sulfonated polyarylenesulfone polymer (sP) according to the present invention by any method known to the skilled person.

Preferably, the membrane (M) comprising the sulfonated polyarylenesulfone polymer (sP) obtainable by the inventive process is prepared by a method comprising the steps
i) providing a solution (S) which comprises the sulfonated polyarylenesulfone polymer (sP) and at least one solvent,
ii) separating the at least one solvent from the solution (S) to obtain the membrane (M).

Another object of the present invention is therefore A process for the preparation of a membrane (M) comprising the sulfonated polyarylenesulfone polymer (sP) obtained by the inventive process comprising the steps
i) providing a solution (S) which comprises the sulfonated polyarylenesulfone polymer (sP) obtained by the inventive process and at least one solvent,
ii) separating the at least one solvent from the solution (S) to obtain the membrane (M).

A further object of the present invention is a membrane (M) which comprises the sulfonated polyarylenesulfone polymer (sP) which is obtainable by the above described process.

Another object of the present invention is a membrane (M) comprising the sulfonated polyarylenesulfone polymer (sP) obtained by the inventive process.

The membrane (M) comprises preferably at least 50% by weight of the sulfonated polyarylenesulfone polymer (sP), more preferably at least 70% by weight and most preferably at least 90% by weight of the sulfonated polyarylenesulfone polymer (sP) based on the total weight of the membrane (M).

The membrane (M) is suitable for the separation of gases out of gas mixtures especially for the separation of hydrogen from hydrogen containing gas mixtures.

Another object of the present invention therefore is the use of the membrane (M) obtained by the inventive process for the separation of gas from gas mixtures

The present invention is more particularly elucidated by the following examples without being restricted thereto.

Components used:
DCDPS 4,4′-dichlorodiphenyl sulfone,
sDCDPS 4,4′-dichlorodiphenylsulfone-3,3′-disulfonic acid disodium salt
BP 4,4′-dihydroxybiphenyl,
K₂CO₃: potassium carbonate, anhydrous, average particle size 32.6 μm
NMP: N-methylpyrrolidone, anhydrous

The viscosity number VN of the sulfonated polyarylenesulfone polymer (sP) was measured according to DIN ISO 1628-1 in a 0.5% by weight NMP solution.

The incorporation ratio (the incorporation rate) of the sDCDPS was determined by ¹H-NMR in CDCl₃. Furthermore, the polymer content of the polymer solutions after filtration was also quantified by ¹H-NMR in CDCl₃.

The content of counter-ion was determined by atomic spectroscopy.

The isolation of the sulfonated polyarylenesulfone polymer (sP) unless otherwise indicated was carried out, by dripping an NMP solution of the sulfonated polyarylenesulfone polymer (sP) into isopropanole at room temperature. The drop height is 0.5 m. The throughput was about 2.5 l per hour. The obtained precipitate was then extracted with water (water throughput 160 l/h) at 85° C. for twenty hours. The material was then dried at a temperature below the glass transition temperature T₉ to a residual moisture content of less than 2% by weight.

The filtration of the product mixture (P_{G}) was done in a heated metal pressure filter using a filter with a 5 μm pore size and 3 bar N₂-pressure. The filter was heated to 60° C. to reduce the viscosity of the reaction mixture.

The yield of the sulfonated polyarylenesulfone polymer (sP) after precipitation was determined gravimetrically.

### COMPARATIVE EXAMPLE 1

In a 4 liter glass reactor fitted with a thermometer, a gas inlet tube and a Dean-Stark-trap, 384.794 g (1.34 mol) of DCDPS, 343.875 g (0.7 mol) of sDCDPS, 372.42 g (2.00 mol) BP and 304.052 g (2.20 mol) of potassium carbonate with a volume average particle size of 32.6 μm were suspended in 1250 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 16 hours, the reaction was stopped by the addition of 1750 ml NMP and cooling down to room temperature (within one hour). The potassium chloride formed in the reaction was removed by filtration. The obtained polymer solution was then precipitated in isopropanol, the resulting polymer precipitate was separated and then extracted with hot water (85° C.) for 20 h. Then the material was dried at 120° C. for 24 h at reduced pressure (<100 mbar).

### COMPARATIVE EXAMPLE 2

In a 4 liter glass reactor fitted with a thermometer, a gas inlet tube and a Dean-Stark-trap, 384.794 g (1.34 mol) of DCDPS, 343.875 g (0.7 mol) of sDCDPS, 372.42 g (2.00 mol) BP and 345.525 g (2.50 mol) of potassium carbonate with a volume average particle size of 32.6 μm were suspended in 1250 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 16 hours, the reaction was stopped by the addition of 1750 ml NMP and cooling down to room temperature (within one hour). The potassium chloride formed in the reaction was removed by filtration. The obtained polymer solution was then precipitated in isopropanol, the resulting polymer precipitate was separated and then extracted with hot water (85° C.) for 20 h. Then the material was dried at 120° C. for 24 h at reduced pressure (<100 mbar).

### EXAMPLE 3

In a 4 liter glass reactor fitted with a thermometer, a gas inlet tube and a Dean-Stark-trap, 384.794 g (1.34 mol) of DCDPS, 343.875 g (0.7 mol) of sDCDPS, 372.42 g (2.00 mol) BP and 400.809 g (2.90 mol) of potassium carbonate with a volume average particle size of 32.6 μm were suspended in 1250 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 8.5 hours, the reaction was stopped by the addition of 1750 ml NMP and cooling down to room temperature (within one hour). The potassium chloride formed in the reaction was removed by filtration. The obtained polymer solution was then precipitated in isopropanol, the resulting polymer precipitate was separated and then extracted with hot water (85° C.) for 20 h. Then the material was dried at 120° C. for 24 h at reduced pressure (<100 mbar).

### EXAMPLE 4

In a 4 liter glass reactor fitted with a thermometer, a gas inlet tube and a Dean-Stark-trap, 258.444 g (0.900 mol) of DCDPS, 309.487 g (0.63 mol) of sDCDPS, 279.315 g (1.50 mol) BP and 321.338 g (2.325 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 8.5 hours, the reaction was stopped by the addition of 2312 ml NMP and cooling down to room temperature (within one hour). The potassium chloride formed in the reaction was removed by filtration. The obtained polymer solution was then precipitated in isopropanol, the resulting polymer precipitate was separated and then extracted with hot water (85° C.) for 20 h. Then the material was dried at 120° C. for 24 h at reduced pressure (<100 mbar).

### EXAMPLE 5

In a 4 liter glass reactor fitted with a thermometer, a gas inlet tube and a Dean-Stark-trap, 223.985 g (0.78 mol) of DCDPS, 368.327 g (0.75 mol) of sDCDPS, 279.315 g (1.50 mol) BP and 345.525 g (2.5 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 8.5 hours, the reaction was stopped by the addition of 2312 ml NMP and cooling down to room temperature (within one hour). The potassium chloride formed in the reaction was removed by filtration. The obtained polymer solution was then precipitated in isopropanol, the resulting polymer precipitate was separated and then extracted with hot water (85° C.) for 20 h. Then the material was dried at 120° C. for 24 h at reduced pressure (<100 mbar).

### COMPARATIVE EXAMPLE 6

In a 4 liter glass reactor fitted with a thermometer, a gas inlet tube and a Dean-Stark-trap, 223.985 g (0.78 mol) of DCDPS, 368.327 g (0.75 mol) of sDCDPS, 279.315 g (1.50 mol) BP and 414.63 g (3 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation.

After a reaction time of 8.5 hours, the reaction was stopped by the addition of 2312 ml NMP and cooling down to room temperature (within one hour). The potassium chloride formed in the reaction was removed by filtration. The obtained polymer solution was then precipitated in isopropanol, the resulting polymer precipitate was separated and then extracted with hot water (85° C.) for 20 h. Then the material was dried at 120° C. for 24 h at reduced pressure (<100 mbar).

TABLE 1

| | C1 | C2 | 3 | 4 | 5 | C6 |
|---|---|---|---|---|---|---|
| condensation Time | 16 | 16 | 8.5 | 8.5 | 8.5 | 8.5 |
| [h] | | | | | | |
| sDCDPS-content in | 34.3 | 34.3 | 34.3 | 41.2 | 49.0 | 49.0 |
| R_{G} [mol %] | | | | | | |
| DCDPS-content in | 65.7 | 65.7 | 65.7 | 58.8 | 51.0 | 51.0 |
| R_{G} [mol %] | | | | | | |
| V.N. | 37.8 | 45.2 | 70.8 | 72.0 | 69.9 | 61.0 |
| [ml/g] | | | | | | |
| sDCDPS-cont. in sP | 30.5 | 30.6 | 32.5 | 38.8 | 46.9 | 44.8 |
| [mol %] | | | | | | |
| Filtration time | 11 | 14 | 16 | 15 | 17 | >24 |
| [h] | | | | | | |
| Yield | 68 | 72 | 88 | 81 | 80 | 72 |
| [wt. %] | | | | | | |
| Z [mol] K2CO3 | 2.2 | 2.5 | 2.9 | 2.325 | 2.5 | 3 |

By using the inventive amount of potassium carbonate, high molecular weight sulfonated polyarylenesulfone polymers (sP) with a high amount of incorporated sDCDPs can be prepared. Surprisingly, the filtration time of the high molecular weight sulfonated polyarylenesulfone polymer (sP) obtained by the inventive process is lower than observed for a high molecular weight product obtained with higher excess of potassium carbonate.

### COMPARATIVE EXAMPLE 7 (C7)

In a 4 liter glass reactor fitted with a thermometer, a gas inlet tube and a Dean-Stark-trap, 288.606 g (1.005 mol) of DCDPS, 257.90 g (0.525 mol) of sDCDPS, 279.315 g (1.500 mol) BP and 248.778 (1.80 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 8 hours, the reaction was stopped by the addition of 1312 ml NMP and cooling down to room temperature (within one hour). The potassium chloride formed in the reaction was removed by filtration. The obtained polymer solution was then divided in two equal portions. One portion was precipitated in isopropanol, the resulting polymer beads were separated and then extracted with hot water (85° C.) for 20 h. Then the beads were dried at 120° C. for 24 h at reduced pressure (<100 mbar).

### Comparative Example 8 (C8)

In a 4 liter glass reactor fitted with a thermometer, a gas inlet tube and a Dean-Stark-trap, 288.606 g (1.005 mol) of DCDPS, 257.90 g (0.5250 mol) of sDCDPS, 279.315 g (1.50 mol) BP and 310.97 g (2.25 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 6.5 hours the torque achieved a plateau, hence the reaction was stopped by the addition of 1312 ml NMP and cooling down to room temperature (within one hour). The potassium chloride formed in the reaction was removed by filtration. The obtained polymer solution was then divided in two equal portions. One portion was precipitated in isopropanol, the resulting polymer beads were separated and then extracted with hot water (85° C.) for 20 h. Then the beads were dried at 120° C. for 24 h at reduced pressure (<100 mbar).

### COMPARATIVE EXAMPLE 9 (C9)

In a 4 liter glass reactor fitted with a thermometer, a gas inlet tube and a Dean-Stark-trap, 288.60 g (1.005 mol) of DCDPS, 257.90 g (0.525 mol) of sDCDPS, 279.315 g (1.50 mol) BP and 248.778 g (1.80 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 8 hours, the reaction was stopped by the addition of 1312 ml NMP and cooling down to room temperature (within one hour). The potassium chloride formed in the reaction was removed by filtration. The obtained polymer solution was then divided in two equal portions. One portion was precipitated in isopropanol, the resulting polymer beads were separated and then extracted with hot water (85° C.) for 20 h. Then the beads were dried at 120° C. for 24 h at reduced pressure (<100 mbar).

### EXAMPLE 10

In a 4 liter glass reactor fitted with a thermometer, a gas inlet tube and a Dean-Stark-trap, 281.273 g (0.9795 mol) of DCDPS, 257.90 g (0.525 mol) of sDCDPS, 279.315 g (1.500 mol) BP and 310.973 (2.25 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 5.7 hours, the reaction was stopped by the addition of 1312 ml NMP and cooling down to room temperature (within one hour). The potassium chloride formed in the reaction was removed by filtration. The obtained polymer solution was then divided in two equal portions. One portion was precipitated in isopropanol, the resulting polymer beads were separated and then extracted with hot water (85° C.) for 20 h. Then the beads were dried at 120° C. for 24 h at reduced pressure (<100 mbar).

### EXAMPLE 11

In a 4 liter glass reactor fitted with a thermometer, a gas inlet tube and a Dean-Stark-trap, 279.981 g (0.975 mol) of DCDPS, 257.90 g (0.525 mol) of sDCDPS, 279.315 g (1.500 mol) BP and 310.973 (2.25 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 5.4 hours, the reaction was stopped by the addition of 1312 ml NMP and cooling down to room temperature (within one hour). The potassium chloride formed in the reaction was removed by filtration. The obtained polymer solution was then divided in two equal portions. One portion was precipitated in isopropanol, the resulting polymer beads were separated and then extracted with hot water (85° C.) for 20 h. Then the beads were dried at 120° C. for 24 h at reduced pressure (<100 mbar).

### COMPARATIVE EXAMPLE 12 (C12)

In a 4 liter glass reactor fitted with a thermometer, a gas inlet tube and a Dean-Stark-trap, 255.52 g (1.005 mol) of DFDPS, 257.90 g (0.525 mol) of sDCDPS, 279.315 g (1.500 mol) BP and 248.778 (1.80 mol) of potassium carbonate with a volume average particle size of 32.6 μm were suspended in 938 ml NMP in a nitrogen atmosphere.

The mixture was heated to 190° C. within one hour. In the following, the reaction time shall be understood to be the time during which the reaction mixture was maintained at 190° C. The water that was formed in the reaction was continuously removed by distillation, losses in NMP were replenished.

After a reaction time of 5 hours, the reaction was stopped by the addition of 1312 ml NMP and cooling down to room temperature (within one hour). The potassium fluoride formed in the reaction was removed by filtration. The obtained polymer solution was then divided in two equal portions. One portion was precipitated in isopropanol, the resulting polymer beads were separated and then extracted with hot water (85° C.) for 20 h. Then the beads were dried at 120° C. for 24 h at reduced pressure (<100 mbar).

TABLE 2

| | C7 | C8 | C9 | 10 | 11 | C12 |
|---|---|---|---|---|---|---|
| condensation Time | 8 | 6.5 | 8 | 5.7 | 5.4 | 5 |
| [h] | | | | | | |
| V.N. | 45.1 | 69.6 | 52.1 | 86.1 | 92.3 | 74.0 |
| [ml/g] | | | | | | |
| sDCDPS-cont. in sP | 30.2 | 33.0 | 31.3 | 33.2 | 33.4 | 33.6 |
| [mol %] | | | | | | |
| mol K⁺ / mol Na⁺ | 1/7 | 1/3 | 1/6 | 3.1/1 | 3.3/1 | 1/13 |

### Characterization of the Films

The sulfonated polyarylenesulfone polymers (sP) from comparative examples C9 and C12 and inventive examples 10 and 11 were dissolved in NMP (20 wt. %) and the solutions were doctor bladed on a glass support with a thickness of 300 μm. The wet films were dried in the vacuum first at room temperature and then the temperature was raised to 140° C. for 12 h. The obtained films (FC9; F10; F11 and FC12) were subsequently separated from the glass plates and extracted with hot water (85° C.) for 4 h, then again dried in a vacuum oven. By H-NMR it was confirmed that the NMP-content of the films was below 0.1 wt. %. Then 2 pieces of each film with a weight of 0.1 g were stored in deionized water until the water up-take did not change anymore and the water content of the film (in %) was determined gravimetrically.

| Film | FC9 | F10 | F11 | FC12 |
|---|---|---|---|---|
| Water | 27 | 16 | 15 | 29 |
| up-take | | | | |
| [wt. %] | | | | |

Surprisingly, the films containing a higher potassium counter-ion content show less water swelling and a better dimensional stability, which is favorable for technical use.

1.-15. (canceled)

16. A process for the preparation of a sulfonated polyarylenesulfone polymer (sP) comprising the step
i) converting a reaction mixture (R_{G}) comprising
X mol of an aromatic dihalogensulfone component (component A)) comprising, based on the total molar amount of the aromatic dihalogensulfone component (component A)) in the reaction mixture (R_{G}),
X¹ mol.-% of at least one sulfonated aromatic dihalogensulfone (component (A1)), and
X² mol.-% of at least one non sulfonated aromatic dihalogensulfone (component (A2)),
wherein X¹ is in the range of 25 to 70 and X² is in the range of 30 to 75,
Y mol of at least one aromatic dihydroxy compound (component (B))
Z mol of at least one carbonate compound (component (C)),
wherein
the ratio of X to Y is in the range of 0.95 to 1.05,
and wherein
Z is in the range of P to Q,
wherein P is calculated according to the following equation:
$$P = Y * ( 1.05 + {X}^{- 1} / 100 * 1.05 ) ,$$
and wherein Q is calculated according to the following equation:
$$Q = Y * ( 1.05 + {X}^{- 1} / 100 * 1.4 ) .$$

17. The process according to claim 16, wherein the reaction mixture (R_{G})) further comprises at least one aprotic polar solvent (component (D)).

18. The process according to claim 16, wherein component (A1) comprises at least one compound selected from the group consisting of 4,4′-dichlorodiphenylsulfone-3,3′-disulfonic acid, 4,4′-dichloro-diphenylsulfone-3,3′-disulfonic acid disodium salt, 4,4′-dichlorodiphenylsulfone-3,3′-disulfonic acid dipotassium salt, 4,4′-difluorodiphenylsulfone-3,3′-disulfonic acid, 4,4′-difluorodiphenylsulfone-3,3′-disulfonic acid disodium salt and 4,4′-difluorodiphenylsulfone-3,3′-disulfonic acid dipotassium salt.

19. The process according to claim 16, wherein component (A2) comprises not less than 80 wt % of at least one aromatic dihalogensulfone selected from the group consisting of 4,4′-dichlorodiphenylsulfone and 4,4′-difluorodiphenylsulfone, based on the overall weight of component (A2) in reaction mixture (R_{G}).

20. The process according to claim 16, wherein component (B) comprises not less than 80 wt % 4,4′-dihydroxybiphenyl, based on the overall weight of component (B) in reaction mixture (R_{G}).

21. The sulfonated polyarylenesulfone polymer (sP) obtained by the process according to claim 16.

22. The sulfonated polyarylenesulfone polymer (sP) according to claim 21, wherein the sulfonated polyarylenesulfone polymer (sP) comprises repeating units of the general formula (I): 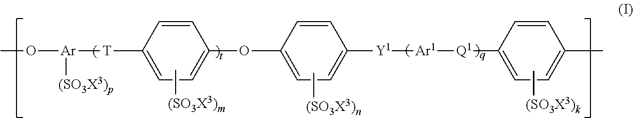
where
t and q: are each independently 0, 1, 2 or 3,
Q¹, T and Y¹: are each independently a chemical bond or selected from —O—, —S—, —SO₂—, —S(═O)—, —C(═O)—, —N═N—, and —CR^{a}R^{b}—,
wherein R^{a} and R^{b} are each independently a hydrogen atom or a C₁-C₁₂-alkyl, C₁-C₁₂-alkoxy or C₆-C₁₈-aryl group, and wherein at least one of Q, T and Y is —SO₂—,
Ar and Ar¹: are each independently C₆-C₁₈ aryl, wherein said C₆-C₁₈ aryl is unsubstituted or substituted with at least one substituent selected from C₁-C₁₂ alkyl, C₁-C₁₂ alkoxy, C₆-C₁₈ aryl, halogen and —SO₃X,
p, m, n, and k: are each independently 0, 1, 2, 3 or 4, with the proviso that the sum total of p, m, n and k is not less than 1, and
X³: is hydrogen or one cation equivalent.

23. The sulfonated polyarylenesulfone polymer (sP) according to claim 21 containing repeating units comprising at least one —SO₃X^{3a} group and/or at least one —SO₃X^{3b} group, wherein X^{3a} and X^{3b} are each independently from each other at least one selected from the group consisting of hydrogen and cation equivalents, wherein at least 50 mol % of the total amount of X^{3a} and X^{3b} contained in the sulfonated polyarylenesulfone polymer (sP) are potassium cations.

24. A sulfonated polyarylenesulfone polymer (sP) containing repeating units comprising at least one —SO₃X^{3a} group and/or at least one —SO₃X^{3b} group,
wherein X^{3a} and X^{3b} are each independently from each other at least one selected from the group consisting of hydrogen and cation equivalents, wherein at least 50 mol % of the total amount of X^{3a} and X^{3b} contained in the sulfonated polyarylenesulfone polymer (sP) are potassium cations.

25. Use of the sulfonated polyarylenesulfone polymer (sP) according to claim 21 for the preparation of membranes (M).

26. A process for the preparation of a membrane (M) comprising the sulfonated polyarylenesulfone polymer (sP) according to claim 21 comprising the steps
i) providing a solution (S) which comprises the sulfonated polyarylenesulfone polymer (sP) according to claim 21 and at least one solvent,
ii) separating the at least one solvent from the solution (S) to obtain the membrane (M).

27. Membrane (M) obtained by the process according to claim 26.

28. Membrane (M) comprising the sulfonated polyarylenesulfone polymer (sP) according to claim 21.

29. Use of the membrane (M) according to claim 27 for the separation of gas from gas mixtures.

30. Use of the membranes (M) according to claim 27 in electrolysis cells, electrodialysis cells and fuel cells.
